(19) United States
(12) Patent Application Publication
(10) Pub. No.: US 2019/0100685 A1
(43) Pub. Date: Apr. 4, 2019

(54) PARAFFIN INHIBITION BY SOLUBILIZED CALIXARENES

(71) Applicant: SI GROUP, INC., Schenectady, NY (US)

(72) Inventor: Robert CABLE, Schenectady, NY (US)

(21) Appl. No.: 15/879,293

(22) Filed: Jan. 24, 2018

Related U.S. Application Data
(60) Provisional application No. 62/567,629, filed on Oct. 3, 2017.

(51) Int. Cl. C09K 8/524; C10G 75/04; C08G 8/12; C08G 8/36; F17D 3/12

(52) U.S. Cl. CPC C09K 8/524; C10G 75/04; F17D 3/12; C08G 8/36; C08G 8/12

(57) ABSTRACT

This invention relates to compositions and a process for stabilizing or improving the solubility of a phenolic resin containing a mixture of linear phenolic resins and calixarenes in a hydrocarbon solvent. This invention also relates to a paraffin-containing fluid composition comprising this stabilized (solubilized) calixarene resin. The invention also relates to methods for dispersing paraffin crystals, inhibiting paraffin crystal deposition, or treating a well or vessel to reduce the deposition of paraffin crystals, with a resin composition containing this stabilized (solubilized) calixarene resin.

This application claims priority to U.S. Provisional Application No. 62/567,629, filed on Oct. 3, 2017, which is herein incorporated by reference in its entirety.

### FIELD OF THE INVENTION

This invention generally relates to a solubilized calixarene compound. For example, the invention relates to methods for dispersing paraffin crystals, inhibiting paraffin crystal deposition, or treating a well or vessel to reduce the deposition of paraffin crystals.

### BACKGROUND

Phenolic resins have been used as components of demulsifier and dehazer formulations, e.g., in oilfield, refining, and fuel applications. These resins are useful for the efficient separation of emulsions, e.g., separating oil from water. Depending how the phenolic resins are prepared, the phenolic resin may contain mainly linear phenolic resins or a mixture of linear phenolic resins and cyclic phenolic resins (e.g., calixarenes). For instance, certain oil field resins can contain 20% or more calixarenes.

It is advantageous to use phenolic resins containing a mixture of linear phenolic resins and cyclic phenolic resins because the linear/cyclic phenolic resin mixture is a more efficient demulsifier in certain oil emulsions compared to the phenolic resin containing mainly linear phenolic resins.

However, using the phenolic resins containing the linear/cyclic phenolic resin mixture can lead to instability (or insolubility) problems associated with the product. When the phenolic resin containing such a mixture is prepared, significant amounts of insolubles will typically precipitate out of the resin solution. Thus, the final product can settle, forming a cake at the bottom of the container, that when stored for even a short period of time, makes it difficult to be processed further. To obviate this problem, the resin material can be made and shipped hot, provided that it is transported only short distances. However, this solution can significantly limit the utilization of the phenolic resin product.

Paraffin deposition is typically of a concern in wells, flowlines, or pipelines carrying paraffin-containing petroleum fluids. Paraffin deposition occurs when pipe and vessel surface temperatures fall below both the bulk paraffin-containing petroleum fluid temperature and the temperature at which paraffins will start to crystallize from the petroleum fluid. Paraffin deposition is particularly problematic in arctic and deepwater subsea flowlines and pipelines due to the cold temperatures of these environments. Gelling of paraffin-containing petroleum fluids can occur due to the formation of a crystalline paraffin lattice network within the fluids. This gelling can result in an increase in the viscosity of the fluid up to the point where the fluids will no longer flow. All these conditions can be undesirable, causing reduced operating efficiencies, shut-ins, and cleaning operation costs.

Despite the growth in the use of oilfield paraffin-control chemicals, technical challenges still exist with respect to the design and application of these chemicals.

Therefore, there is a need in the art to develop phenolic resins containing a mixture of linear and cyclic phenolic resins with improved solubility and stability in a hydrocarbon solvent. There is also a need in the petroleum fluid production industry to develop new chemistries to address paraffin deposition control and pour point depression, and the technology gaps existing in currently available commercial paraffin inhibitors. This invention answers those needs.

### SUMMARY OF THE INVENTION

One aspect of the invention relates to a paraffin-containing fluid composition comprising: a) a paraffin-containing fluid; and b) a resin at least partially soluble in the paraffin-containing fluid, for dispersing the paraffin in the fluid composition and/or inhibiting the deposition of the paraffin crystals. The resin comprises one or more modified calixarene compounds, each modified calixarene compound comprising 4-20 units of formula

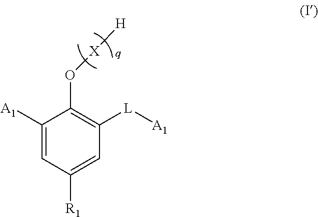

and/or formula

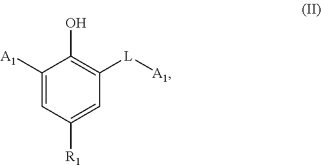

wherein each X is independently the same or different moiety, each moiety having a structure of

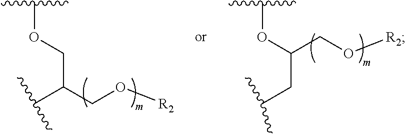

each R₁ is independently a H, C₁ to C₃₀ alkyl, phenyl, or arylalkyl; each R₂ is independently a H, C₁ to C₂₀ branched or unbranched alkyl which may optionally be substituted with one or more glycidyl ether units of the formula

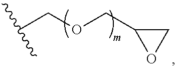

C₂ to C₁₀ alkenyl, or C₅ to C₁₀ aryl; each L is independently selected from the group consisting of —CH₂—, —C(O)—, —CH(R₃)—, —(CH₂)ₙ—O—(CH₂)ₙ—, —C(R₃)₂—, and —S—; each R₃ is independently a C₁-C₆ alkyl; each m is independently an integer from 0 to 10; each n is independently an integer from 1 to 2; each q is independently an integer from 1 to 100; each A₁ represents a direct covalent bond to an adjacent unit of formula (I′) or formula (II) such that there is one L group between adjacent units, whereby the total units in the calixarene compound form a ring; and wherein units of formula (I′) make up from about 35% to 100% of the overall units present in the calixarene compound.

In some embodiments, each m is 1. In one embodiment, each R₂ is independently selected from the group consisting of hydrogen, methyl, ethyl, n-propyl, iso-propyl, n-butyl, iso-butyl, tert-butyl, allyl, ethylhexyl, octyl, nonyl, decyl, phenyl, nonylphenyl, and hexadecyl. For instance, each R₂ is n-butyl. In one embodiment, each R₂ is a C₁ to C₈ branched or unbranched alkyl substituted with one or more glycidyl ether units of the formula

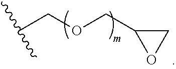

For instance, each R₂ is

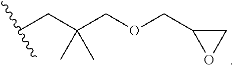 [SMILES: *CC(C)(C)COCC1CO1]

In some embodiments, each R₁ is independently a C₄ to C₁₂ alkyl or C₂₄ to C₂₈ alkyl. In one embodiment, each R₁ is independently tert-butyl, nonyl, or tert-octyl.

In one embodiment, the total number of units in the modified calixarene compounds is from 4-8.

In some embodiments, q is independently an integer from 1 to 20. In one embodiment, q is 1 in one or more units in the modified calixarene compounds.

In one embodiment, the paraffin-containing fluid is a hydrocarbon fluid selected from the group consisting of a crude oil, home heating oil, lubricating oil, and natural gas.

In some embodiments, the paraffin-containing fluid contains at least 0.05 wt % of paraffin or paraffin wax. In one embodiment, the paraffin-containing fluid contains about 0.5 to about 15 wt % of paraffin or paraffin wax.

In some embodiments, the amount of the resin is from about 1 to about 10,000 parts per million in the paraffin-containing fluid. In one embodiment, the amount of the resin is from about 10 to about 100 parts per million in the paraffin-containing fluid.

Another aspect of the invention relates to a method for dispersing paraffin crystals and/or inhibiting paraffin crystal deposition in a paraffin-containing fluid. The method comprises adding to a paraffin-containing fluid, an effective amount of a resin at least partially soluble in the paraffin-containing fluid. The resin comprises one or more modified calixarene compounds, each modified calixarene compound comprising 4-20 units of formula

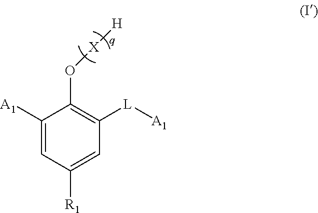

and/or formula

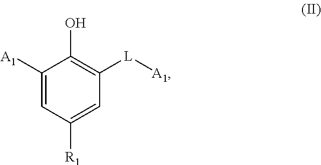

wherein each X is independently the same or different moiety, each moiety having a structure of

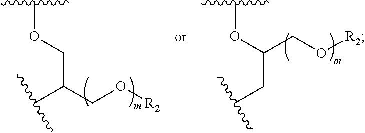

each R₁ is independently a H, C₁ to C₃₀ alkyl, phenyl, or arylalkyl; each R₂ is independently a H, C₁ to C₂₀ branched or unbranched alkyl which may optionally be substituted with one or more glycidyl ether units of the formula

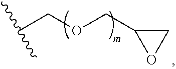

C₂ to C₁₀ alkenyl, or C₅ to C₁₀ aryl; each L is independently selected from the group consisting of —CH₂—, —C(O)—, —CH(R₃)—, —(CH₂)ₙ—O—(CH₂)ₙ—, —C(R₃)₂—, and —S—; each R₃ is independently a C₁-C₆ alkyl; each m is independently an integer from 0 to 10; each n is independently an integer from 1 to 2; each q is independently an integer from 1 to 100; each A₁ represents a direct covalent bond to an adjacent unit of formula (I′) or formula (II) such that there is one L group between adjacent units, whereby the total units in the calixarene compound form a ring; and wherein units of formula (I′) make up from about 35% to 100% of the overall units present in the calixarene compound. The resin disperses the paraffin in the paraffin-containing fluid and/or inhibits the deposition of the paraffin crystals.

In some embodiments, each m is 1. In one embodiment, each R₂ is independently selected from the group consisting of hydrogen, methyl, ethyl, n-propyl, iso-propyl, n-butyl, iso-butyl, tert-butyl, allyl, ethylhexyl, octyl, nonyl, decyl, phenyl, nonylphenyl, and hexadecyl. For instance, each R₂ is n-butyl. In one embodiment, each R₂ is a C₁ to C₈ branched or unbranched alkyl substituted with one or more glycidyl ether units of the formula

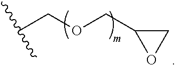

For instance, each R₂ is

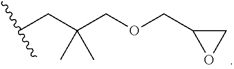 [SMILES: *CC(C)(C)COCC1CO1]

In some embodiments, each R₁ is independently a C₄ to C₁₂ alkyl or C₂₄ to C₂₈ alkyl. In one embodiment, each R₁ is independently tert-butyl, nonyl, or tert-octyl.

In one embodiment, the total number of units in the modified calixarene compounds is from 4-8.

In some embodiments, each q is independently an integer from 1 to 20. In one embodiment, q is 1 in one or more units in the modified calixarene compounds.

In one embodiment, the well or vessel surface is the surface of a gas well, oil well, pipeline, flowline, tank, tank car, or processing vessel.

In some embodiments, the resin composition further comprises a fluid that the resin is at least partially soluble in. For instance, the fluid is a hydrocarbon fluid selected from the group consisting of a crude oil, home heating oil, lubricating oil, and natural gas. In one embodiment, the fluid is a paraffin-containing fluid. The paraffin-containing fluid may contain at least 0.05 wt % of paraffin or paraffin wax. For instance, the paraffin-containing fluid contains about 0.5 to about 15 wt % of paraffin or paraffin wax. In one embodiment, the fluid comprises one or more hydrocarbon solvents. For instance, the hydrocarbon solvents are selected from the group consisting of kerosene, diesel, heptane, benzene, toluene, xylene, C₉-C₁₂ aromatic hydrocarbon solvents, and combinations thereof. In one embodiment, the amount of the resin is from about 1 to about 10,000 parts per million in the fluid. For instance, the amount of the resin is from about 10 to about 100 parts per million in the fluid.

Another aspect of the invention relates to a method for treating a well or vessel surface to reduce the deposition of paraffin crystals on the well or vessel surface. The method comprises treating the well or vessel surface with a resin composition comprising an effective amount of a resin. The resin comprises one or more modified calixarene compounds, each modified calixarene compound comprising 4-20 units of formula

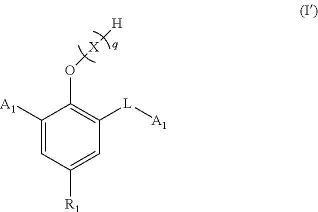

and/or formula

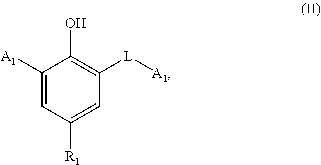

wherein each X is independently the same or different moiety, each moiety having a structure of

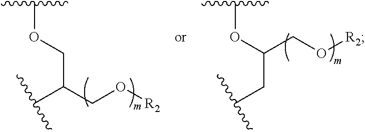

each R₁ is independently a H, C₁ to C₃₀ alkyl, phenyl, or arylalkyl; each R₂ is independently a H, C₁ to C₂₀ branched or unbranched alkyl which may optionally be substituted with one or more glycidyl ether units of the formula

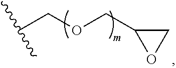

C₂ to C₁₀ alkenyl, or C₅ to C₁₀ aryl; each L is independently selected from the group consisting of —CH₂—, —C(O)—, —CH(R₃)—, —(CH₂)ₙ—O—(CH₂)ₙ—, —C(R₃)₂—, and —S—; each R₃ is independently a C₁-C₆ alkyl; each m is independently an integer from 0 to 10; each n is independently an integer from 1 to 2; each q is independently an integer from 1 to 100; each A₁ represents a direct covalent bond to an adjacent unit of formula (I′) or formula (II) such that there is one L group between adjacent units, whereby the total units in the calixarene compound form a ring; and wherein units of formula (I′) make up from about 35% to 100% of the overall units present in the calixarene compound. The treatment reduces the deposition of paraffin crystals on the well or vessel surface.

In some embodiments, each m is 1. In one embodiment, each R₂ is independently selected from the group consisting of hydrogen, methyl, ethyl, n-propyl, iso-propyl, n-butyl, iso-butyl, tert-butyl, allyl, ethylhexyl, octyl, nonyl, decyl, phenyl, nonylphenyl, and hexadecyl. For instance, each R₂ is n-butyl. In one embodiment, each R₂ is a C₁ to C₈ branched or unbranched alkyl substituted with one or more glycidyl ether units of the formula

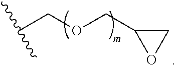

For instance, each R₂ is

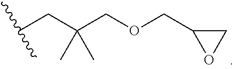 [SMILES: *CC(C)(C)COCC1CO1]

In some embodiments, each R₁ is independently a C₄ to C₁₂ alkyl or C₂₄ to C₂₈ alkyl. In one embodiment, each R₁ is independently tert-butyl, nonyl, or tert-octyl.

In one embodiment, the total number of units in the modified calixarene compounds is from 4-8.

In one embodiment, the paraffin-containing fluid is a hydrocarbon fluid selected from the group consisting of a crude oil, home heating oil, lubricating oil, and natural gas.

In some embodiments, the paraffin-containing fluid contains at least 0.05 wt % of paraffin or paraffin wax. In one embodiment, the paraffin-containing fluid contains about 0.5 to about 15 wt % of paraffin or paraffin wax.

In some embodiments, the amount of the resin is from about 1 to about 10,000 parts per million in the paraffin-containing fluid. In one embodiment, the amount of the resin is from about 10 to about 100 parts per million in the paraffin-containing fluid. The resin improves the paraffin dispersion and/or inhibits the paraffin deposition by at least 20% compared to a paraffin-containing fluid composition that does not contain the resin. For instance, the resin improves the paraffin dispersion and/or inhibits the paraffin deposition by at least 40% compared to a paraffin-containing fluid composition that does not contain the resin.

### BRIEF DESCRIPTION OF THE DRAWINGS

FIG. 1 shows the paraffin inhibition performance (% inhibition) of an exemplary solubilized calixarene resin in a simulated waxy crude at different dosage levels (1000 ppm, 500 ppm, 250 ppm, and 100 ppm, respectively). The solubilized calixarene resin and the simulated waxy crude are described in Example 3.

### DETAILED DESCRIPTION OF THE INVENTION

This invention relates to a resin comprising one or more modified calixarene compounds with improved solubility in a hydrocarbon solvent at both room temperature and cold temperatures, e.g., at −25° C., which may be used, by itself or in combination with other materials, to inhibit paraffin crystal deposition or disperse paraffin crystals. The solubility of the resulting phenolic resin is dramatically improved, resulting in a stable, easy to handle calixarene/linear phenolic resin, which may be used, by itself or in combination with other materials, to inhibit paraffin crystal deposition or disperse paraffin crystals. The resulting solubilized calixarene resin can disperse paraffin crystals and/or inhibit paraffin crystal deposition in a paraffin-containing fluid. The paraffin inhibiting performance of the solubilized calixarene resins was evaluated on simulated crude oils as well as various oilfield crude oils, which showed that the solubilized calixarene resins exhibited paraffin inhibiting abilities. The solubilized calixarene resin can thus be useful in the oilfield industry to reduce the paraffin deposition on well or vessel surfaces, as well as in industrial product markets to disperse paraffin crystals in a fluid matrix.

### Solubilized Calixarene Resin and its Preparation

One aspect of the invention relates to a resin comprising one or more modified calixarene compounds, each calixarene compound comprising 4-20 units of formula (I) and/or formula (II):

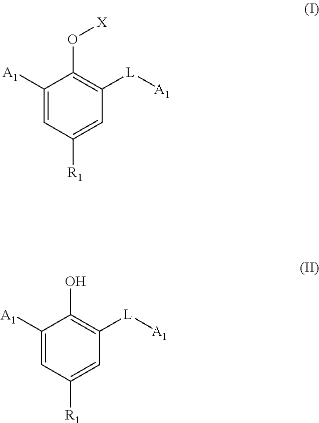

wherein each X is independently

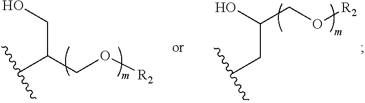

each R₁ is independently a H, C₁ to C₃₀ alkyl, phenyl, or arylalkyl; each R₂ is independently a H, C₁ to C₂₀ branched or unbranched alkyl which may optionally be substituted with one or more glycidyl ether units of the formula

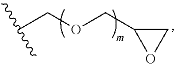

C₂ to C₁₀ alkenyl, or C₅ to C₁₀ aryl; each L is independently selected from the group consisting of —CH₂—, —C(O)—, —CH(R₃)—, —(CH₂)ₙ—O—(CH₂)ₙ—, —C(R₃)₂—, and —S—; each R₃ is independently a C₁-C₆ alkyl; each m is independently an integer from 0 to 10, for instance, from 0 to 3; each n is independently an integer from 1 to 2; each A₁ represents a direct covalent bond to an adjacent unit of formula (I) or formula (II) such that there is one L group between adjacent units, whereby the total units in the calixarene compound form a ring; and wherein units of formula (I) make up from about 35% to 100% of the overall units present in the calixarene compound.

The term “stable” is used herein as a measure of solubility, i.e., whether the phenolic resins containing the linear/cyclic phenolic resin mixture are soluble enough so that when the phenolic resin containing such a mixture is prepared, significant amounts of insolubles will not precipitate out of the resin solution, and the resulting resin would be suitable for storage and/or can be more easily handled or transported at room temperature without precipitation.

The phenolic resins of the invention include a mixture of linear phenolic resins and cyclic phenolic resins, such as calixarenes.

The linear phenolic resins may contain a substituent on the benzene ring, at either the ortho or para position to the hydroxyl of linear phenolic resins. Typically, the linear phenolic resin has a structure of Formula (A):

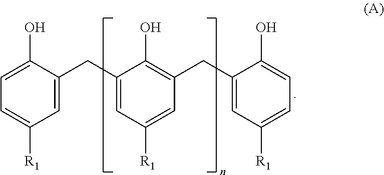

The substituent group on the benzene ring of the linear phenolic resin (R₁ in Formula (A)) may be independently H, C₁ to C₃₀ alkyl, phenyl, or arylalkyl. For instance, the substituent group (R₁ in Formula (A)) may be independently C₄ to C₁₈ alkyl, C₄ to C₁₂ alkyl, or C₁ to C₇ alkyl. In one embodiment, at least one substituent group (R₁ in Formula (A)) on the benzene ring of the linear phenolic resin is C₁ to C₅ alkyl, such as C₄ or C₅ alkyl. The number of repeating units of the linear phenolic resin (n in Formula (A)) may be 2 to 20, for instance, 2 to 10, 2 to 8, 2 to 6, or 2 to 4, resulting in a molecular weight typically ranging from about 500 to about 10,000 daltons, for instance, from about 500 to about 5,000 daltons, or from about 500 to about 3,000 daltons.

The phenolic resins contain calixarenes ranging from about 35% to about 100%, for instance, from about 40% to about 90%, from about 50% to about 90%, from about 50% to about 80%, or from about 55% to about 75%.

The term “calixarene” generally refers to a variety of derivatives that may have one or more substituent groups on the hydrocarbons of cyclo{oligo[(1,3-phenylene)methylene]}. The calixarenes may contain a substituent on the benzene ring of calixarenes. Typically, the calixarene has a structure of Formula (B):

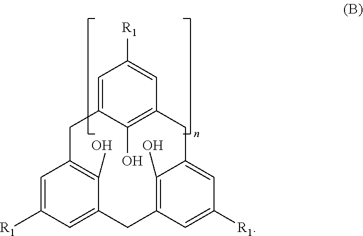

The substituent group on the benzene ring of the calixarene (R₁ in Formula (B)) may be independently H, C₁ to C₃₀ alkyl, phenyl, or arylalkyl. For instance, the substituent group (R₁ in Formula (B)) may be independently C₄ to C₁₈ alkyl, C₄ to C₁₂ alkyl, or C₁ to C₇ alkyl. In one embodiment, at least one substituent group (R₁ in Formula (A)) on the benzene ring of the calixarene is C₁ to C₅ alkyl, such as C₄ or C₅ alkyl. The number of repeating units of the calixarene (n in Formula (II)) may be 2 to 20, for instance, 2 to 10, 2 to 8, 2 to 6, or 2 to 4, resulting in a molecular weight typically ranging from about 500 to about 10,000 daltons, for instance, from about 500 to about 5,000 daltons, or from about 500 to about 3,000 daltons. An exemplary calixarene structure is shown as below, wherein n is 2.

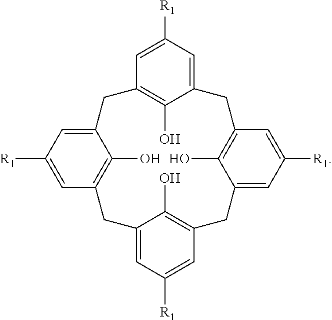

The calixarene compounds of the invention comprise 4-20 units of formula (I) and/or formula (II):

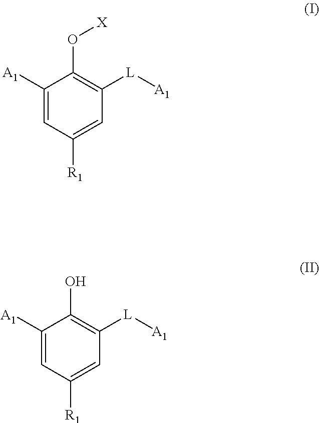

wherein each A₁ represents a direct covalent bond to an adjacent unit of formula (I) or formula (II) such that there is one L group between adjacent units, whereby the total units in the calixarene compound form a ring; and wherein units of formula (I) make up from about 35% to 100% of the overall units present in the calixarene compound. Thus, in the context of the invention, when a calixarene compound comprises 4 units of formula (I) and/or formula (II), the calixarene may range from having one unit of formula (I) and 3 units of formula (II), having the structure of

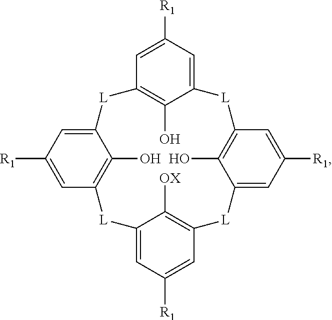

to having all four units of the calixarene as formula (I), having the structure of

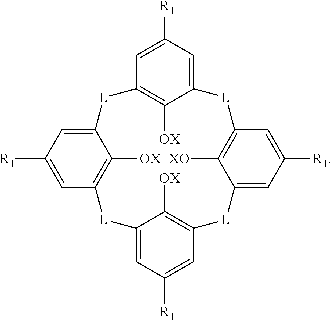

The calixarene compounds of the invention comprise 4-20 units of formula (I) and/or formula (II). For example, the calixarene compounds contain from 4-8 units, 2-6 units, 4-6 units, or 6 units.

The resins of the invention are modified to impart higher solubility in solvents. For example, the resins of the invention are modified to impart higher solubility in hydrocarbon solvents, such as aromatic hydrocarbon solvents (e.g., a C₇-C₁₂ aromatic hydrocarbon solvent or combinations thereof). Exemplary aromatic hydrocarbon solvents used in this invention include toluene, xylenes, tetralin, ShellSol® A150 (“A150,” a C₉-C₁₀ aromatic hydrocarbon solvent) produced by Shell, ShellSol® A150ND (“A150ND,” a C₉-C₁₀ aromatic hydrocarbon solvent with naphthalene depleted) produced by Shell and other aromatic hydrocarbon solvents known to one skilled in the art, such as Solvesso™ 150 produced by ExxonMobil Chemical (a C₁₀-C₁₂ aromatic hydrocarbon solvent).

In the context of the invention, phenolic hydroxyl groups of the resins are modified via alkoxylation with epoxide-containing compounds of formula (III):

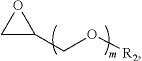

where R₂ is H, C₁ to C₂₀ branched or unbranched alkyl which may optionally be substituted with one or more glycidyl ether units of the formula

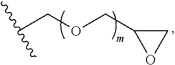

C₂ to C₁₀ alkenyl, or C₅ to C₁₀ aryl; and m is an integer from 0 to 10, for instance, from 0 to 8, from 0 to 6, or from 0 to 3, such as 1 or 2, resulting in higher stabilization to the resin. It will be appreciated by one having skill in the art that a higher degree of alkoxylation results in a higher imparted stability in the resins of the invention.

In one embodiment, phenolic hydroxyl groups of the resins are modified via alkoxylation with epoxide-containing compounds of formula (III):

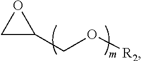

where m is 1 or 2. In an embodiment, R₂ is selected from the group consisting of hydrogen, methyl, ethyl, n-propyl, iso-propyl, n-butyl, iso-butyl, tert-butyl, allyl, ethylhexyl, octyl, nonyl, decyl, phenyl, nonylphenyl, and hexadecyl. For example, the phenolic hydroxyl groups of the resins are modified via alkoxylation with n-butyl glycidyl ether.

Alternatively, phenolic hydroxyl groups of the resins are modified via alkoxylation with epoxide-containing compounds of formula (III):

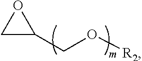

where m is 0. In an embodiment, R₂ is selected from the group consisting of hydrogen, methyl, ethyl, n-propyl, iso-propyl, n-butyl, iso-butyl, tert-butyl, allyl, ethylhexyl, octyl, nonyl, decyl, phenyl, nonylphenyl, and hexadecyl. For example, the phenolic hydroxyl groups of the resins are modified via alkoxylation with 2-phenyloxirane.

In another embodiment, phenolic hydroxyl groups of the resins are modified via alkoxylation with epoxide containing compounds of formula (III):

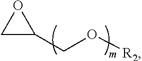

where R₂ is a C₁ to C₂₀ branched or unbranched alkyl which may optionally be substituted with one or more glycidyl ether units of the formula

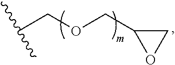

where m is an integer from 0 to 10, for instance, from 0 to 8, from 0 to 6, or from 0 to 3. For instance, the compound of formula (III) is a diglycidyl ether, triglycidyl ether, or tetraglycidyl ether, where R₂ is a C₁ to C₂₀ branched or unbranched alkyl, such as a C₁-C₈ branched or unbranched alkyl, or a C₃-C₆ branched alkyl, where the R₂ group is substituted with one, two, or three glycidyl ether units, respectively, of the formula

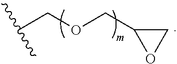

In one embodiment, the diglycidyl ether in the R₂ group is neopentyl glycol diglycidyl ether, where R₂ is

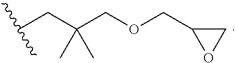 [SMILES: *CC(C)(C)COCC1CO1]

The phenolic hydroxyl groups of the resins may or may not all be alkoxylated with epoxide-containing compounds of formula (III). The resins of the invention contain calixarenes having from 35% to 100% of their phenolic hydroxyl groups having been alkoxylated and all integer ranges therebetween. For example, from about 40% to about 90%, from about 50% to about 90%, from about 50% to about 80%, or from about 55% to about 75% of the phenolic hydroxyl groups have been alkoxylated with the compound of formula (III).

In an embodiment of the invention, the calixarene compounds of the invention comprise 4-20 units of formula (I) and/or formula (II):

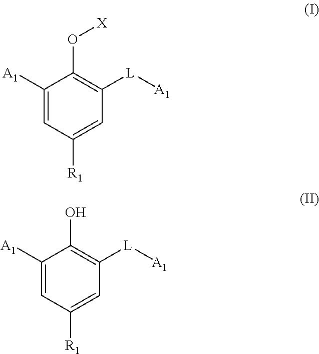

where each R₁ is independently a C₄ to C₁₂ alkyl group. Each R₁ may independently be a tert-butyl, nonyl, or tert-octyl group. The solubility improvement is particularly useful to those calixarene compounds having a lower alkyl as the R₁ substituent. For instance, calixarene compounds in which at least one R₁ group is C₁ to C₅ alkyl, such as C₄ or C₅ alkyl. Alternatively, the R₁ groups are higher alkyl substituents. For example, each R₁ may be a C₂₄ to C₂₈ alkyl group. The calixarene compound may contain units of formula (I) and/or formula (II) independently containing random combinations of various R₁ groups.

In an embodiment, the one or more units in the modified calixarene compounds has the structure of

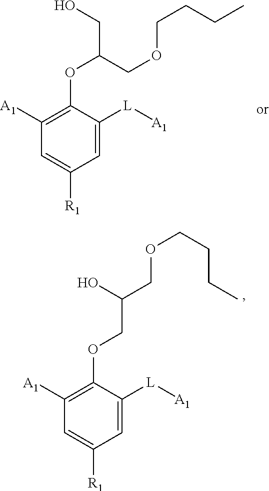

wherein: each R₁ is independently a C₄ to C₁₂ alkyl, and the total number of units in the calixarene compounds is from 4-8. The phenolic hydroxyl groups of the resin may react with an epoxide at the less-substituted and/or more-substituted epoxide carbon, resulting in regioisomer formation. The regioselectivity of the alkoxylation can be controlled by means apparent to one having skill in the art, for instance, by controlling solvent selection, sterics, and/or pH.

Adjacent phenol rings of the phenol resin are connected together through an L group. For example, two units of formula (I) connected together have the structure of

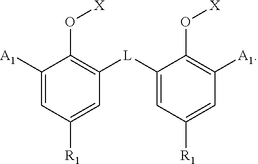

L groups are selected from the group consisting of —CH₂—, —C(O)—, —CH(R₃)—, —(CH₂)ₙ—O—(CH₂)ₙ—, —C(R₃)₂—, and —S—; where each R₃ is independently a C₁-C₆ alkyl; and each n is independently an integer from 1 to 2. For example, L may be —CH₂— or —CH₂—O—CH₂—.

Another aspect of the invention relates to a resin solution of a phenolic resin, comprising one or more modified calixarene compounds, which may be used, by itself or in combination with other materials, to inhibit paraffin crystal deposition or disperse paraffin crystals. Each calixarene compound comprises 4-20 units of formula (I′),

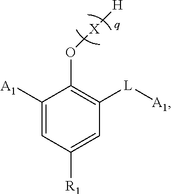

and/or formula (II),

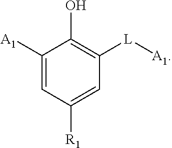

Each X is independently the same or different moiety, each moiety having a structure of

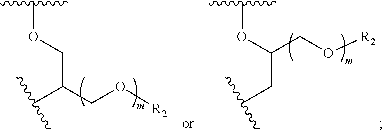

each R₁ is independently a H, C₁ to C₃₀ alkyl, phenyl, or arylalkyl; each R₂ is independently a H, C₁ to C₂₀ branched or unbranched alkyl which may optionally be substituted with one or more glycidyl ether units of the formula

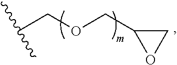

C₂ to C₁₀ alkenyl, or C₅ to C₁₀ aryl; each L is independently selected from the group consisting of —CH₂—, —C(O)—, —CH(R₃)—, —(CH₂)ₙ—O—(CH₂)ₙ—, —C(R₃)₂—, and —S—; each R₃ is independently a C₁-C₆ alkyl; each m is independently an integer from 0 to 10; each n is independently an integer from 1 to 2; each q is independently an integer from 1 to 100; and each A₁ represents a direct covalent bond to an adjacent unit of formula (I′) or formula (II) such that there is one L group between adjacent units, whereby the total units in the calixarene compound form a ring. The phenolic resin is soluble in a hydrocarbon solvent having a concentration of about 50 wt % to about 75 wt %.

The units of formula (I′) make up from about 35% to 100% of the overall units present in the calixarene compound, for instance, from about 40% to about 90%, from about 50% to about 90%, from about 50% to about 80%, or from about 55% to about 75% of the overall units present in the calixarene compound.

The modified calixarene compounds comprise 4-20 units of formula (I′) and/or formula (II). For example, the modified calixarene compounds can contain from 4 to 8 units, from 2 to 6 units, from 4 to 6 units, or 6 units of formula (I′) and/or formula (II).

In Formula (I′), each X is independently

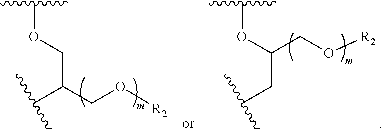

The variable X is the result from the alkoxylations of the phenolic hydroxyl groups of the calixarene compounds with epoxide-containing compounds of formula (III):

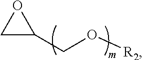

as described above. X is selected from the two regioisomers because, as described above, the phenolic hydroxyl groups may react with an epoxide at the less-substituted and/or more-substituted epoxide carbon, resulting in regioisomer formation. Depending on the degree of alkoxylation, the modified calixarene compound can contain q units of X, which can be a random combination of the two regioisomers. One skilled in the art would understand that the two [symbol] in each structure represent the connection points of the X moiety to the formula, so that the carbon atom of the X moiety is connected to the oxygen atom in the phenolic unit of formula (I′) or in a different X moiety, and the oxygen atom of the X moiety is connected to the carbon atom in a different X moiety or to the hydrogen atom of formula (I′). For instance, an illustrative structure of formula (I′) containing two units of X moieties can have a structure of

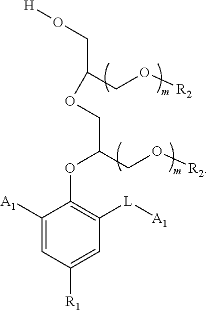

Each q is independently an integer from 1 to 100. The variable q represents the degree of alkoxylation by the compound of formula (III). For instance, each q in each unit of the formula (I′) can be independently 1 to 50, 1 to 20, 1 to 10, 1 to 5, 1 to 3, 1 to 2, or 1. In one embodiment, q is 1 in one or more units in the modified calixarene compounds.

The alkoxylations of the phenolic hydroxyl groups of the calixarene compounds by reacting, on average, 1 mole of the compounds of formula (III) for each mole of the phenolic units of the phenolic resin may produce a calixarene compound in which q is 1 on each phenolic unit. It is possible, however, such alkoxylation may also produce a calixarene compound in which q is 2 or more on one or more phenolic units whereas the phenolic hydroxyl groups on other phenolic units of the calixarene compound are left unmodified, as in Formula (II), in which q would effectively be zero. It is also possible that such alkoxylation may produce certain calixarene compounds in which the q values vary on one or more of their phenolic units, and certain calixarene compounds that are completely unmodified, i.e., q is zero in each of their phenolic units.

In formulas (I′) and (II), each R₁ is independently a H, C₁ to C₃₀ alkyl, phenyl, or arylalkyl. Exemplary R₁ groups are C₄ to C₁₂ alkyls. For instance, each R₁ is independently tert-butyl, tert-octyl, nonyl, or combinations thereof. In one embodiment, at least one R₁ group is C₁ to C₅ alkyl, such as C₄ or C₅ alkyl. Other exemplary R₁ groups are higher alkyl substituents, such as a C₂₄ to C₂₈ alkyl group. The calixarene compound may contain units of formula (I′) and/or formula (II) independently containing random combinations of various R₁ groups.

In the phenolic resins, one or more phenolic hydroxyl groups of the resins are modified via alkoxylation with epoxide-containing compounds of formula (III):

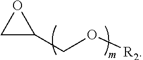

As discussed above, each m is independently an integer from 0 to 10, for instance, from 0 to 8, from 0 to 6, or from 0 to 3. Each R₂ is independently a H, C₁ to C₂₀ branched or unbranched alkyl which may optionally be substituted with one or more glycidyl ether units of the formula

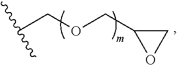

C₂ to C₁₀ alkenyl, or C₅ to C₁₀ aryl.

In certain embodiments, each m is independently 1 or 2. For instance, each m is 1. In certain embodiments, each R₂ is independently selected from the group consisting of hydrogen, methyl, ethyl, n-propyl, iso-propyl, n-butyl, iso-butyl, tert-butyl, allyl, ethylhexyl, octyl, nonyl, decyl, phenyl, nonylphenyl, and hexadecyl. For instance, R₂ may be butyl, such as n-butyl. In this case, each X would independently have a structure of

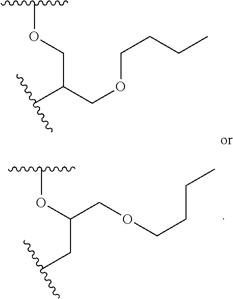 [SMILES: *OCC(*)COCCCC ; *CC(COCCCC)O*]

Alternatively, each R₂ may be independently a C₁ to C₂₀ branched or unbranched alkyl which may optionally be substituted with one or more glycidyl ether units of the formula

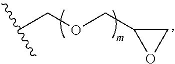

in which m is as defined above. For instance, each R₂ can be independently a C₁ to C₈ branched or unbranched alkyl, substituted with one glycidyl ether units of the formula

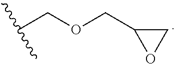

### Exemplary R₂ is

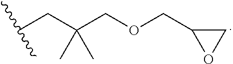 [SMILES: *CC(C)(C)COCC1CO1]

In this case, each X would independently have a structure of

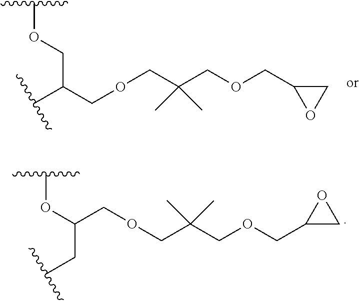 [SMILES: *OCC(*)COCC(C)(C)COCC1CO1 ; *CC(COCC(C)(C)COCC1CO1)O*]

In certain embodiments, each m is 0. In one embodiment, each R₂ is independently selected from the group consisting of hydrogen, methyl, ethyl, n-propyl, iso-propyl, n-butyl, iso-butyl, tert-butyl, allyl, ethylhexyl, octyl, nonyl, decyl, phenyl, nonylphenyl, and hexadecyl. Exemplary R₂ is phenyl. In this case, each X would independently have a structure of

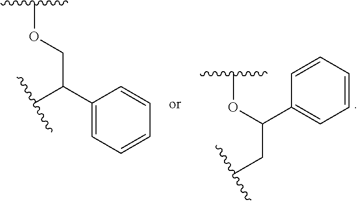 [SMILES: *OCC(*)c1ccccc1 ; *CC(O*)c1ccccc1]

In the calixarene compounds, whether modified or unmodified, adjacent phenol rings of the phenol resin are connected together through an L group. Each A₁ represents a direct covalent bond to an adjacent unit of formula (I′) or formula (II) such that there is one L group between adjacent units, whereby the total units in the calixarene compound form a ring. Each L group is selected from the group consisting of —CH₂—, —C(O)—, —CH(R₃)—, —(CH₂)ₙ—O—(CH₂)ₙ—, —C(R₃)₂—, and —S—, in which each R₃ is independently a C₁-C₆ alkyl and each n is independently an integer from 1 to 2. For example, L may be —CH₂— or —CH₂—O—CH₂—.

In some embodiments, one or more modified calixarene compounds have one or more units of formula (I′) represented by the structure of

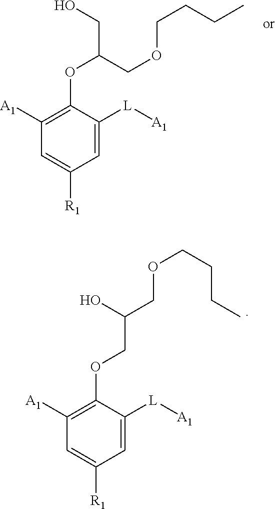

Each R₁ is independently a C₄ to C₁₂ alkyl; each L is independently selected from the group consisting of —CH₂—, —C(O)—, —CH(R₃)—, —(CH₂)ₙ—O—(CH₂)ₙ—, and —C(R₃)₂—; each R₃ is independently a C₁-C₆ alkyl; each n is independently an integer from 1 to 2; and the total number of units in the calixarene compounds is from 4 to 8. In one embodiment, each R₁ is independently tert-butyl, tert-octyl, nonyl, or combinations thereof. In one embodiment, at least one R₁ group is C₁ to C₅ alkyl, such as C₄ or C₅ alkyl. In one embodiment, each L is independently —CH₂— or —CH₂—O—CH₂—. In one embodiment, the units of formula (I′) having the above structure make up from about 50% to about 90% of the overall units present in the calixarene compound. For example, the units of formula (I′) having the above structure make up from about 50% to about 80%, or from about 55% to about 75% of the overall units present in the calixarene compound.

After the alkoxylation with the compounds of formula (III), the resulting phenolic resins become soluble in a hydrocarbon solvent, such as an aromatic hydrocarbon solvent, resulting in a highly concentrated resin solution that can have the concentration of the linear/cyclic phenolic resin to about 50 wt % to about 75 wt %. As discussed above, exemplary aromatic hydrocarbon solvents are toluene, xylene, tetralin, a C₉-C₁₀ aromatic hydrocarbon solvent (such as ShellSol® A150 or ShellSol® A150ND), or a C₁₀-C₁₂ aromatic hydrocarbon solvent (such as Solvesso™ 150).

The term “resin solution” means that the linear/cyclic phenolic resin mixture is soluble in a hydrocarbon solvent, as discussed above, capable of forming a resin solution that is substantially free of undissolved solid components, under a wide range of temperatures. Also, the linear/cyclic phenolic resin mixture is soluble enough that the resulting resin solution can be handled, transported, or stored for a long period of time under a wide range of temperatures without precipitation. For instance, the resin is soluble in a hydrocarbon solvent at room temperature or above, at 10° C. or above, at 0° C. or above, at −10° C. or above, at −20° C. or above, or at −25° C. or above. For instance, after the storage of 24 hours or longer, less than 20%, less than 10%, or less than 5% of solid components precipitate out of the solvent from the resin solution.

Accordingly, another aspect of the invention relates to a resin with an increased solubility in a hydrocarbon solvent, comprising one or more modified calixarene compounds, which may be used, by itself or in combination with other materials, to inhibit paraffin crystal deposition or disperse paraffin crystals. Each calixarene compound comprises 4-20 units of formula (I′),

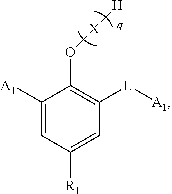

and/or formula (II),

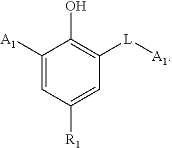

Each X is independently the same or different moiety, each moiety having a structure of

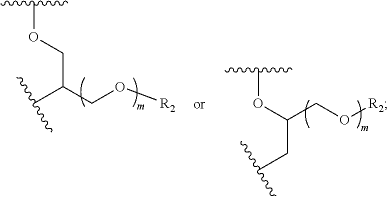

each R₁ is independently a H, C₁ to C₃₀ alkyl, phenyl, or arylalkyl; each R₂ is independently a H, C₁ to C₂₀ branched or unbranched alkyl which may optionally be substituted with one or more glycidyl ether units of the formula

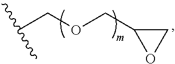

C₂ to C₁₀ alkenyl, or C₅ to C₁₀ aryl; each L is independently selected from the group consisting of —CH₂—, —C(O)—, —CH(R₃)—, —(CH₂)ₙ—O—(CH₂)ₙ—, —C(R₃)₂—, and —S—; each R₃ is independently a C₁-C₆ alkyl; each m is independently an integer from 0 to 10; each n is independently an integer from 1 to 2; each q is independently an integer from 1 to 100; and each A₁ represents a direct covalent bond to an adjacent unit of formula (I) or formula (II) such that there is one L group between adjacent units, whereby the total units in the calixarene compound form a ring. The units of formula (I′) make up from about 35% to 100% of the overall units present in the calixarene compound.

The solubility of the resin is increased by at least 20%, for instance, at least 40%, at least 50%, at least 60%, at least 80%, at least 100%, or at least 120%, compared to a resin comprising calixarene compounds containing units of formula (II) but no units of formula (I′).

This invention also relates to a process for stabilizing or solubilizing a phenolic resin containing a mixture of linear phenolic resins and cyclic phenolic resins (e.g., calixarene) to improve the solubility of the phenolic resin in a hydrocarbon solvent. The solubilized phenolic resin may be used, by itself or in combination with other materials, to inhibit paraffin crystal deposition or disperse paraffin crystals. The phenolic resin containing calixarenes is modified with an epoxide of formula (III), generating a partially alkoxylated derivative that is soluble in a hydrocarbon solvent at both room temperature and cold temperatures, e.g., at −25° C. Accordingly, the solubility of the resulting phenolic resin is dramatically improved, resulting in a stable, easy to handle calixarene/linear phenolic resin mixture intermediate for utilization as a demulsifier to separate oil and water emulsion in applications such as oilfield, petroleum, and fuel applications.

An aspect of the invention relates to a process for stabilizing or solubilizing a phenolic resin mixture. The resulting phenolic resin mixture may be used, by itself or in combination with other materials, to inhibit paraffin crystal deposition or disperse paraffin crystals. The process comprises: reacting a phenolic resin mixture comprising linear phenolic resins and calixarene compounds having pendant phenolic hydroxyl groups with one or more compounds of formula (III):

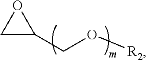

an optional catalyst, and at least one hydrocarbon solvent at an elevated temperature for a period of time sufficient to alkoxylate one or more of the phenolic hydroxyl groups of the linear phenolic resins and/or calixarene compounds in the phenolic resin mixture to result in a resin solution substantially free of undissolved solid components, wherein the solubility of the phenolic resin mixture is increased by at least 20% compared to a phenolic resin mixture that is not subjected to said reacting step, wherein R₂ is a H, C₁ to C₂₀ branched or unbranched alkyl which may optionally be substituted with one or more glycidyl ether units of the formula

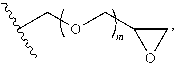

C₂ to C₁₀ alkenyl, or C₅ to C₁₀ aryl; and m is an integer from 0 to 10, for instance, from 0 to 8, from 0 to 6, or from 0 to 3. On average, about 0.1 to about 100 moles, about 0.1 to about 20 moles, about 0.2 to about 3 moles, or about 0.2 to 1 mole of the compounds of formula (III) may react with the phenolic hydroxyl groups of the calixarene compounds for each mole of the phenolic units of the phenolic resin.

This process forms a stabilized phenolic resin with an increased solubility in a hydrocarbon solvent as compared to an unmodified phenolic resin that has not been subjected to such process. The stabilized phenolic resin may be used, by itself or in combination with other materials, to inhibit paraffin crystal deposition or disperse paraffin crystals

The catalyst in the process is optional and may be used to accommodate faster reaction times and/or lower reaction temperatures. In an embodiment, the catalyst is present in the process and is a base catalyst. Typical base catalysts used are selected from the group consisting of sodium hydroxide, potassium hydroxide, sodium carbonate, potassium carbonate, sodium bicarbonate, potassium bicarbonate, triethylamine, imidazole, 2-methylimidazole, pyridine, and combinations thereof. For instance, the catalyst may be 2-methylimidazole. The amount of catalyst, if present, may range from about 0.01 wt % to about 5 wt %. For example, the amount of catalyst, if present, may range from about 0.02 wt % to about 5 wt %, or from about 0.5 wt % to about 3 wt %, or from about 0.1 wt % to about 1 wt %, or from about 0.1 wt % to about 0.5 wt %, or from about 0.2 wt % to about 0.3 wt %.

The process for stabilizing a phenolic resin mixture is carried out at an elevated temperature, for instance, temperatures in the range of 110-170° C., such as 125-160° C., 140-155° C., or 145-155° C.

In an embodiment, less than 5% of residual compound of formula (III) remains unreacted within 1 hour of the start of the reaction (i.e., when the compound of formula (III) is added to the reaction system), for instance, less than 3%, or less than 1% of residual compound of formula (III) can remain unreacted within 1 hour of the start of the reaction.

As noted above, R₂ in formula (III):

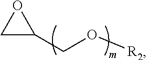

can be H, C₁ to C₂₀ branched or unbranched alkyl which may optionally be substituted with one or more glycidyl ether units of the formula

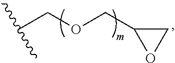

C₂ to C₁₀ alkenyl, or C₅ to C₁₀ aryl. Alternatively, R₂ can be hydrogen, methyl, ethyl, n-propyl, iso-propyl, n-butyl, iso-butyl, tert-butyl, allyl, ethylhexyl, octyl, nonyl, decyl, phenyl, nonylphenyl, and hexadecyl, and m=1. For example, R₂ can be n-butyl glycidyl ether.

The unmodified calixarene compounds of the invention comprise 4-20 units of formula (II):

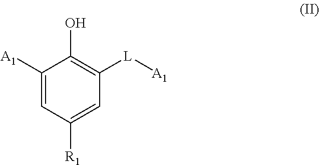

wherein each R₁ is independently a H, C₁ to C₃₀ alkyl, phenyl, or arylalkyl; each L is independently selected from the group consisting of —CH₂—, —C(O)—, —CH(R₃)—, —(CH₂)ₙ—O—(CH₂)ₙ—, —C(R₃)₂—, and —S—; each R₃ is independently a C₁-C₆ alkyl; each n is independently an integer from 1 to 2; each A₁ represents a direct covalent bond to an adjacent unit of formula (II) such that there is one L group between adjacent units, whereby the total units in the calixarene compound form a ring.

In one embodiment, each R₁ is independently a C₄ to C₁₂ or C₂₄ to C₂₈ alkyl; and wherein the total number of units in the calixarene compounds is from 4-8. In one embodiment, at least one R₁ group is C₁ to C₅ alkyl, such as C₄ or C₅ alkyl.

The stabilized or solubilized phenolic resin prepared from the processes described herein contain calixarenes having from 35% to 100% of their phenolic hydroxyl groups having been alkoxylated and all ranges therebetween. In one example, at least 35% of the phenolic hydroxyl groups in the resin have been alkoxylated with the compound of formula (III). In another example, at least 40% of the phenolic hydroxyl groups in the resin have been alkoxylated with the compound of formula (III). In another example, at least 50% of the phenolic hydroxyl groups in the resin have been alkoxylated with the compound of formula (III). In another example, at least 75% of the phenolic hydroxyl groups in the resin have been alkoxylated with the compound of formula (III). In another example, at least 90% of the phenolic hydroxyl groups in the resin have been alkoxylated with the compound of formula (III). In another example, at least 95% of the phenolic hydroxyl groups in the resin have been alkoxylated with the compound of formula (III).

The typical reaction process involves heating and mixing the calixarene containing resin slurry in aromatic hydrocarbon solvent, optionally, adding catalyst (e.g., 2-methylimidazole), at 30-50° C. The epoxide of formula (III) (e.g., a glycidyl ether) is then added and the mixture is heated to 125-155° C. The slurry appearance typically becomes noticeably darker as the reaction product becomes soluble in the aromatic solvent. In most cases this begins at 130° C. The mixture typically becomes completely soluble in the aromatic solvent at 125-155° C. after mixing for 10-30 minutes and the resulting solution is clear. Once clear the mixture is held at temperature for one to two hours to complete the reaction. The solution is cooled and analyzed for residual epoxide to determine completeness of the reaction. Typically, less than 1% residual epoxide remains under this procedure.

Using glycidyl ethers (i.e., m=1) to stabilize the calixarene-containing resins confers numerous advantages over other known methods in the art for stabilizing calixarene-containing phenolic resins (e.g., alkoxylation with alkylene carbonates). For example, the temperature required in the stabilization reaction procedure is much lower than similar techniques. Using a glycidyl ether to alkoxylate a phenolic resin typically allows for a temperature of 30-50° C. less than alkylene carbonates (e.g., 140° C. for glycidyl ethers compared to 170-180° C. for alkylene carbonates). Additionally, using glycidyl ethers leads to much shorter processing times for solubilizing calixarenes. Procedures using other stabilization techniques call for a reaction time of 3 hours or greater compared to the process disclosed in this invention, which can typically be completed in 2 hours or less. This procedure is also attractive because there are no byproducts normally associated with the stabilization of phenolic resins. For example, no carbon dioxide is evolved using glycidyl ethers. Resins stabilized with epoxides of formula (III), such as glycidyl ethers, are also observed to solubilize linear para-tert-butylphenol chains.

The phenolic resins, e.g., phenolic novolac resins, can be prepared in any suitable manner known in the art for preparation of phenolic resins. Typically, one or more phenolic compounds are reacted with an aldehyde to form a phenolic resin. An additional aldehyde may be added later to adjust the desirable melt point of the phenolic resin. Examples of such processes can be found in U.S. Pat. No. 7,425,602 to Howard et al., which is hereby incorporated by reference in its entirety, to the extent not inconsistent with the subject matter of this disclosure.

The reaction of the phenolic compound and the aldehyde is conducted in the presence of a base catalyst. Such base-catalyzed reaction results in phenolic resins containing a mixture of linear phenolic resins and calixarenes.

Alternatively, the reaction of the phenolic compound and the aldehyde can also be carried out under high-dilution conditions. For instance, the reaction of the phenolic compound and the aldehyde may be conducted in the presence of a large amount of a solvent, e.g., with the solvent concentration of about 80 wt %.

Suitable phenolic compounds for preparing the phenolic resins include phenol and its derivatives, which may contain one or more substituents on the benzene ring of the phenolic compound, at either the ortho or para position to the hydroxyl of the phenolic compound. If the substituent group is at the para position to the hydroxyl group of the phenolic compound, the resulting alkylene bridge (e.g., methylene bridge if formaldehyde is used) extends in the ortho positions to the hydroxyl group of the phenolic compound. If the substituent group is at the ortho position to the hydroxyl group of the phenolic compound, the resulting alkylene bridge can extend in the para position to the hydroxyl group of the phenolic compound and the other substituted ortho position to the hydroxyl group of the phenolic compound.

The substituent on the benzene ring of the phenolic compound may be C₁-C₃₀ alkyl, phenyl, or arylalkyl. Typically, the phenolic compound contains one C₁ to C₁₈ alkyl substituent at the para position. Exemplary phenolic compounds are phenol and alkylphenols including para-methylphenol, para-tert-butylphenol (PTBP), para-sec-butylphenol, para-tert-hexylphenol, para-cyclohexylphenol, para-tert-octylphenol (PTOP), para-isooctylphenol, para-decylphenol, para-dodecylphenol, para-tetradecyl phenol, para-octadecylphenol, para-nonylphenol, para-pentadecylphenol, and para-cetylphenol.

The phenolic resins may be prepared from one or more phenolic compounds reacting with an aldehyde forming an oligomer of repeating units of phenolic monomers. The resulting linear phenolic resin may be a homopolymer of phenolic monomer, or a copolymer containing different units of phenolic monomers, e.g., when two or more different phenolic compounds were reacted with an aldehyde. Similarly, the resulting calixarenes may be a homopolymer of phenolic monomer or a copolymer containing different units of phenolic monomers.

Any aldehyde known in the art for preparing a phenolic resin is suitable in this process. Exemplary aldehydes include formaldehyde, methylformcel, butylformcel, acetaldehyde, propionaldehyde, butyraldehyde, crotonaldehyde, valeraldehyde, caproaldehyde, heptaldehyde, benzaldehyde, as well as compounds that decompose to aldehyde such as paraformaldehyde, trioxane, furfural, hexamethylenetriamine, aldol, β-hydroxybutyraldehyde, and acetals, and mixtures thereof. A typical aldehyde used is formaldehyde.

To prepare a phenolic resin, the molar ratio of the total amount of an aldehyde to phenolic compounds is in the range from 0.5:1 to 1:1, for instance, from 0.8:1 to 1:1, or from 0.9:1 to 1:1.

The phenolic resins prepared from the above process contain a mixture of linear phenolic resins and cyclic phenolic resins, such as calixarenes. The solubility of calixarenes in these resins is typically poor and, thus, undissolved solids often precipitate out of the resin solution once the phenolic resins are prepared. Typically, about 20 wt % to 40 wt % of the phenolic resins precipitate out of the resin solution almost immediately after the resins are produced, causing the instability of the resins for subsequent utilization. Once these insolubles precipitate out, it is difficult to dissolve the solids in the resin solution, thus reducing the amount of active ingredients (i.e., linear phenolic resins and cyclic phenolic resins) in the resin solution for further utilization and making the handling and transportation of the resin product difficult.

In an aspect of this invention, the phenolic resins are contacted with an epoxide-containing compound of formula (III), an optional catalyst, and at least one hydrocarbon solvent at an elevated temperature for a period of time sufficient to alkoxylate one or more of the phenolic hydroxyl groups of the linear phenolic resins and/or calixarene compounds in the phenolic resin mixture. The phenolic hydroxyl groups of the linear phenolic resins can also be at least partially alkoxylated. By this process, a stabilized phenolic resin is formed with an increased solubility and reduced Tg (glass transition temperature) of the resins, which can provide various benefits. For example, when the molecular weight of the phenolic resin is increased, e.g., to the range of 6000 to 10000 daltons, the molten viscosity of the resin is high and the resin can become difficult to process. More solvent can be added to reduce the viscosity of the resin, as has been done in conventional processes, but this creates other issues.

The alkoxylation (or etherification) of the phenolic hydroxyl groups of the linear phenolic resin by an epoxide-containing compound of formula (III) (e.g., n-butyl glycidyl ether) is illustrated in the following exemplary scheme, Scheme 1. The alkoxylation (or etherification) of the phenolic hydroxyl groups of the calixarene phenolic resin by an epoxide of formula (III) (e.g., n-butyl glycidyl ether) is illustrated in the following exemplary scheme, Scheme 2. Schemes 1 and 2 are for illustrative purposes only, and as such they only reflect the formation of one regioisomer (i.e., alkoxylation at the less substituted epoxide-carbon). In practice, the resins may remain unalkoxylated, partially alkoxylated, or fully alkoxylated, with one or both regioisomers forming.

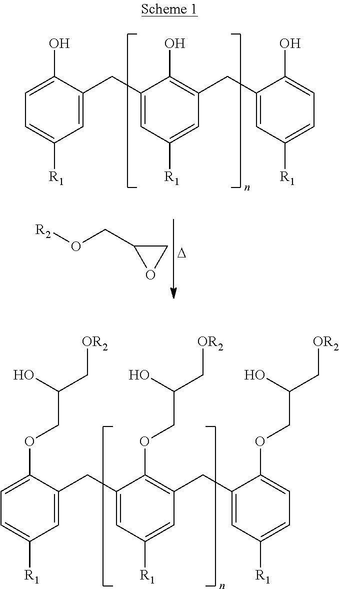

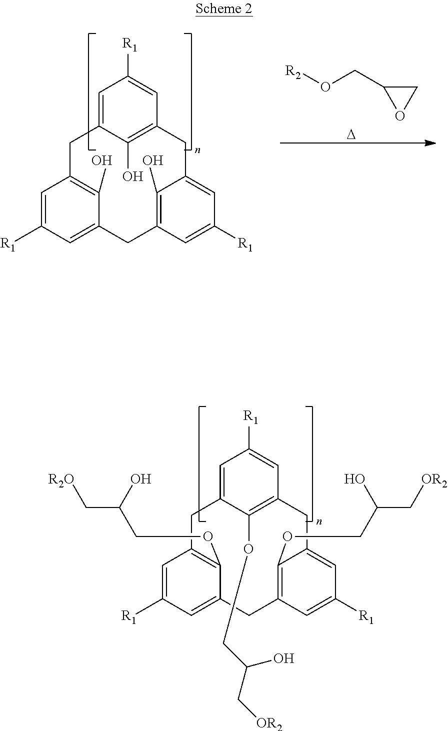

In the above schemes, R₁ may be H, C₁ to C₃₀ alkyl, phenyl, or arylalkyl. Each n is independently 2 to 18. Each R₂ is a H, C₁ to C₂₀ branched or unbranched alkyl which may optionally be substituted with one or more glycidyl ether units of the formula

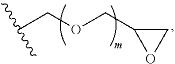

C₂ to C₁₀ alkenyl, or C₅ to C₁₀ aryl, where m is an integer from 0 to 10, for instance, from 0 to 8, from 0 to 6, or from 0 to 3.

The modified calixarene compounds described above can exist in one or more stereoisomeric form, depending on the reaction conditions for the alkoxylations of the calixarenes. For example, in Scheme 2 above, the hydrophilic alkoxylated group may extend all on one side of the calixarene plane (the calixarene plane being the macrocyclic ring formed by the calixarene phenolic units); or, alternatively, they may extend on both sides of the calixarene plane.

The amount of epoxide-containing compound of formula (III) added to react with the phenolic resins is in a molar ratio of the epoxide-containing compound of formula (III) to the phenolic hydroxyl units of the phenolic resins ranging from 0.1:1 to 100:1, for instance, from 0.1:1 to 20:1, from 0.2:1 to 3:1, or from 0.2:1 to 2:1. For example, the molar ratio of epoxide-containing compound of formula (III) to phenolic hydroxyl units of the phenolic resins can be greater than 0.2:1, for instance, from 0.25:1 to 1:1, 0.9:1 to 1.2:1, or about 1:1. When greater than 0.25 moles of an epoxide-containing compound of formula (III) is added to 1 mole of the phenolic resins mixture, a complete dissolution of the calixarenes is achieved, resulting in a clear or mostly clear resin solution containing 40-60% resins be weight in an aromatic solvent.

Advantageously, the process of the invention reduces the molten viscosity of the resin without adding additional solvent. The resulting products thus contain a higher percentage of active materials (i.e., linear phenolic resins and cyclic phenolic resins) in the resin solution and a lower percentage of solvent in the resin solution. Accordingly, the process can reduce cost (including the cost in production and in transportation logistics), and improve processing (less solvent is used, yet with improved solubility and molten viscosity).

After the reaction of the phenolic resins with an epoxide of formula (III), the solubility of the linear phenolic resin/calixarene in a hydrocarbon solvent can be significantly increased, compared to the solubility of the linear phenolic resin/calixarene in the hydrocarbon solvent without subjecting the resin mixture to such process, for instance, by at least 20%, at least 40%, at least 50%, at least 60%, at least 80%, at least 100%, or at least 120%. The hydrocarbon solvent is typically contained in the resulting stabilized phenolic resin because the phenolic resin is typically prepared in the presence of a hydrocarbon solvent, as discussed in the embodiments above.

Accordingly, the reaction of the phenolic resins with an epoxide of formula (III), less than 30% of the calixarenes precipitate out of the solvent after the storage of 24 hours or longer. For instance, less than 20%, less than 10%, or less than 5% of the calixarenes precipitate out of the solvent after the storage of 24 hours or longer. When an appropriate amount of epoxide is reacted with the phenolic resin, the resulting stabilized phenolic resin can be a resin solution substantially free of undissolved solid components, without adding additional solvents to the reaction system, at a temperature of −25° C. or above, for instance at −20° C. or above, at −10° C. or above, at 0° C. or above, at 10° C. or above, or at 20° C. or above.

Another aspect of the invention relates to a stabilized or solubilized phenolic resin prepared from the process described above. A stabilized or solubilized phenolic resin can be prepared by reacting a phenolic resin mixture comprising linear phenolic resins and calixarene compounds having pendant phenolic hydroxyl groups with one or more compounds of formula (III):

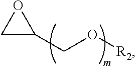

an optional catalyst, and at least one hydrocarbon solvent at an elevated temperature for a period of time sufficient to alkoxylate one or more of the phenolic hydroxyl groups of the linear phenolic resins and/or calixarene compounds in the phenolic resin mixture to result in a resin solution substantially free of undissolved solid components, wherein the solubility of the phenolic resin mixture is increased by at least 20% compared to a phenolic resin mixture that is not subjected to said reacting step, wherein R₂ is a H, C₁ to C₂₀ branched or unbranched alkyl which may optionally be substituted with one or more glycidyl ether units of the formula

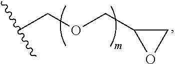

C₂ to C₁₀ alkenyl, or C₅ to C₁₀ aryl; and m is an integer from 0 to 0, for instance, from 0 to 8, from 0 to 6, or from 0 to 3.

On average, about 0.1 to about 100 moles, about 0.1 to about 20 moles, about 0.2 to about 3 moles, or about 0.2 to 1 mole of epoxide-containing compound of formula (III) may react with the phenolic hydroxyl groups of the calixarene compounds for each mole of the phenolic units of the phenolic resin.

In the stabilized or solubilized phenolic resins prepared by the process described above, at least 35% of the phenolic hydroxyl groups in the resin have been alkoxylated. For example, at least 40% of the phenolic hydroxyl groups in the resin have been alkoxylated. For example, at least 50% of the phenolic hydroxyl groups in the resin have been alkoxylated. For example, at least 75% of the phenolic hydroxyl groups in the resin have been alkoxylated. For example, at least 90% of the phenolic hydroxyl groups in the resin have been alkoxylated. For example, at least 95% of the phenolic hydroxyl groups in the resin have been alkoxylated.

### Solubilized Calixarene Resin as Paraffin Inhibitors

One aspect of the invention relates to a paraffin-containing fluid composition comprising: a) a paraffin-containing fluid; and b) a resin at least partially soluble in the paraffin-containing fluid, for dispersing the paraffin in the fluid composition and/or inhibiting the deposition of the paraffin crystals. The resin comprises one or more modified calixarene compounds, each modified calixarene compound comprising 4-20 units of formula

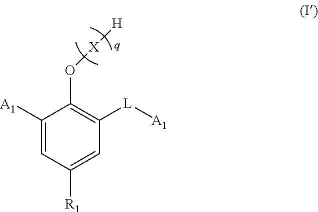

and/or formula

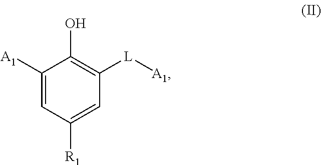

wherein each X is independently the same or different moiety, each moiety having a structure of

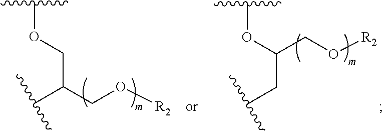

each R₁ is independently a H, C₁ to C₃₀ alkyl, phenyl, or arylalkyl; each R₂ is independently a H, C₁ to C₂₀ branched or unbranched alkyl which may optionally be substituted with one or more glycidyl ether units of the formula

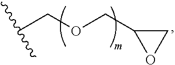

C₂ to C₁₀ alkenyl, or C₅ to C₁₀ aryl; each L is independently selected from the group consisting of —CH₂—, —C(O)—, —CH(R₃)—, —(CH₂)ₙ—O—(CH₂)ₙ—, —C(R₃)₂—, and —S—; each R₃ is independently a C₁-C₆ alkyl; each m is independently an integer from 0 to 10; each n is independently an integer from 1 to 2; each q is independently an integer from 1 to 100; each A₁ represents a direct covalent bond to an adjacent unit of formula (I′) or formula (II) such that there is one L group between adjacent units, whereby the total units in the calixarene compound form a ring; and wherein units of formula (I′) make up from about 35% to 100% of the overall units present in the calixarene compound.

The resin used in the paraffin-containing fluid composition is the same stabilized (or solubilized) phenolic resin described in the above embodiments. After the stabilization (or solubilization) modifications as discussed in the above embodiments, the phenolic resin becomes the solubilized calixarene resin that is soluble, or at least partially soluble, in the paraffin-containing fluid. Accordingly, all the descriptions in the above embodiments relating to the stabilized (or solubilized) phenolic resin and the process of preparing thereof are applicable in the paraffin-containing fluid composition.

The weight average molecular weight of the resin used herein may range from about 500 to about 25,000 daltons, from about 1000 to about 10,000 daltons, from about 1000 to about 8,000 daltons, from about 1000 to about 5,000 daltons, or from about 2000 to about 5000 daltons. Increasing the molecular weight of the resin may increase the paraffin inhibition performance of the resin.

Additionally, as discussed above, the resin used in the paraffin-containing fluid composition is the same solubilized phenolic resin described in the above embodiments, which can be prepared by reacting a phenolic resin mixture comprising linear phenolic resins and calixarene compounds with one or more compounds of formula (III). The resulting resin therefore can be a mixture of cyclic calixarene compounds and linear phenolic compounds. For instance, the resulting resin can contain about 0-50% linear phenolic compounds and about 50-100% cyclic calixarene compounds. Typically, the resulting resin contains about 40-50% linear phenolic compounds and about 50-60% cyclic calixarene compounds.

The paraffin-containing fluid can be any hydrocarbon fluids in the oilfield that contain paraffin or paraffin wax. The term “hydrocarbon fluid” as used herein encompasses an oil and gas. The paraffin-containing hydrocarbon fluids include, but are not limited to a crude oil, home heating oil, lubricating oil (such as an engine oil), and natural gas. After the stabilization modifications as discussed in the above embodiments, the stabilized phenolic resin has an improved solubility in a hydrocarbon solvent, so that the resin becomes soluble, or at least partially soluble, in the paraffin-containing fluid.

The paraffin-containing fluid can contain various amounts of paraffin or paraffin wax. For instance, the paraffin-containing fluid may contain at least 0.05 wt % of paraffin or paraffin wax, at least 0.1 wt % of paraffin or paraffin wax, at least 0.5 wt % of paraffin or paraffin wax, at least 1 wt % of paraffin or paraffin wax, at least 2 wt % of paraffin or paraffin wax, at least 3 wt % of paraffin or paraffin wax, at least 4 wt % of paraffin or paraffin wax, at least 5 wt % of paraffin or paraffin wax, at least 10 wt % of paraffin or paraffin wax, and up to about 15 wt % of paraffin or paraffin wax.

The solubilized calixarene resins discussed herein are paraffin inhibitors that can disperse the paraffin in the fluid composition and/or inhibit the deposition of the paraffin crystals. By “paraffin inhibitor,” the term refers to the ability of the solubilized calixarene resins to modify the morphology and surface properties of paraffin crystals, thereby inhibiting paraffin crystal precipitation, deposition, and/or any other mechanisms, or to disperse the paraffin crystals in the fluid composition, working as a surfactant.

An effective paraffin-inhibiting amount or dosage of the solubilized calixarene resin in the fluid, e.g., the paraffin-containing fluid, refers to the amount or dosage of the solubilized calixarene resin added to the paraffin-containing fluid that can present at least some level of paraffin inhibition (i.e., decreasing the level of paraffin crystal precipitation, deposition, and/or other any other mechanisms of paraffin wax formation), as compared to the paraffin-containing fluid that does not contain the solubilized calixarene resin or any other paraffin inhibitors. Typically, increasing the dosage of the calixarene resin can enhance the paraffin inhibition performance. However, the paraffin inhibition performance is not always improved with increased dosage; too high a dosage of the calixarene resin may decrease the paraffin inhibition performance. The amount of the resin can typically range from about 1 to about 10,000 parts per million (ppm) in the paraffin-containing fluid, from about 10 to about 5000 parts per million in the paraffin-containing fluid, from about 10 to about 1000 parts per million in the paraffin-containing fluid, from about 10 to about 500 parts per million in the paraffin-containing fluid, or from about 10 to about 100 parts per million in the paraffin-containing fluid. In practice, the measurement of the dosage rate may be in μL/L, which is commonly used as an approximation for ppm in the oilfield industry.

Evaluation of the paraffin inhibition performance can be based on various methods known by one skilled in the art. For example, the cold finger test (using a cold finger device) is typically used for such evaluations. A typical cold finger device contains a temperature-controlled metal probe that is inserted into samples of stirred paraffin-containing fluid for specified time duration, usually about 16 hours. The cold finger probe is set to a temperature below the Wax Appearance Temperature (WAT) of the paraffin-containing fluid. The “bulk” paraffin-containing fluid temperature is generally set at or slightly above the WAT of the paraffin-containing fluid and is controlled at the surface of the wall of the bottle containing the paraffin-containing fluid sample. With proper control of the bulk paraffin-containing fluid and cold finger temperatures, a driving force for the paraffin deposition—i.e., the temperature difference between the bulk paraffin-containing fluid and the cold finger probe—can be set such that the cold finger set-up can be used to simulate a section of flow line in a production system. The cold finger surface simulates a cold flowline surface and stirring simulates the flowline flow-field. The amount of paraffin deposition on the cold finger probes after testing can be examined to evaluate the differences in the paraffin-containing fluid that are treated with the solubilized calixarene resin versus those that are not treated with the solubilized calixarene resin (control). The percent inhibition of the paraffin wax deposition by the resin can be determined by comparing the weight of the deposit from the treated sample against the weight of the deposit from the control.

As shown in the examples below, the solubilized calixarene resin improves the dispersion and/or inhibits the paraffin deposition, as compared to a paraffin-containing fluid composition that does not contain the resin, by at least 5%, at least 10%, at least 15%, at least 20%, at least 25%, at least 30%, at least 35%, at least 40%, at least 45%, at least 50%, at least 60%, at least 70%, at least 80%, at least 90%, or at least 95%.

Another aspect of the invention relates to a method for dispersing paraffin crystals or inhibiting paraffin crystal deposition in a paraffin-containing fluid. The method comprises adding to a paraffin-containing fluid, an effective amount of a resin at least partially soluble in the paraffin-containing fluid. The resin comprises one or more modified calixarene compounds, each modified calixarene compound comprising 4-20 units of formula

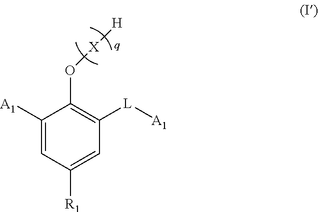

and/or formula

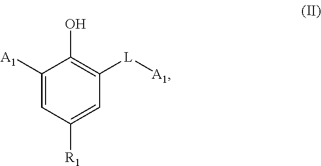

wherein each X is independently the same or different moiety, each moiety having a structure of

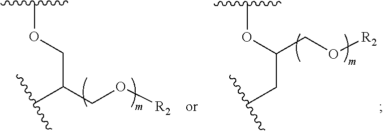

each R₁ is independently a H, C₁ to C₃₀ alkyl, phenyl, or arylalkyl; each R₂ is independently a H, C₁ to C₂₀ branched or unbranched alkyl which may optionally be substituted with one or more glycidyl ether units of the formula

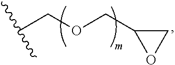

C₂ to C₁₀ alkenyl, or C₅ to C₁₀ aryl; each L is independently selected from the group consisting of —CH₂—, —C(O)—, —CH(R₃)—, —(CH₂)ₙ—O—(CH₂)ₙ—, —C(R₃)₂—, and —S—; each R₃ is independently a C₁-C₆ alkyl; each m is independently an integer from 0 to 10; each n is independently an integer from 1 to 2; each q is independently an integer from 1 to 100; each A₁ represents a direct covalent bond to an adjacent unit of formula (I′) or formula (II) such that there is one L group between adjacent units, whereby the total units in the calixarene compound form a ring; and wherein units of formula (I′) make up from about 35% to 100% of the overall units present in the calixarene compound. The resin disperses the paraffin in the paraffin-containing fluid and/or inhibits the deposition of the paraffin crystals.

The resin used in the method for dispersing paraffin crystals and/or inhibiting paraffin crystal deposition in a paraffin-containing fluid is the same stabilized phenolic resin described in the above embodiments. As discussed above, after the stabilization (or solubilization) modifications, the phenolic resin becomes the solubilized calixarene resin that is soluble, or at least partially soluble, in the paraffin-containing fluid. Accordingly, all the descriptions in the above embodiments relating to the stabilized (or solubilized) phenolic resin and the process of preparing thereof are applicable in the method for dispersing paraffin crystals or inhibiting paraffin crystal deposition in a paraffin-containing fluid.

Moreover, all the above embodiments relating to the paraffin-containing fluid, the amounts of paraffin or paraffin wax contained in the paraffin-containing fluid, the amounts or dosages of the solubilized calixarene resin in the paraffin-containing fluid, the evaluating methods for the paraffin inhibition performance, and the paraffin inhibition abilities of the solubilized calixarene resins described in the embodiments relating to the paraffin-containing fluid composition are applicable in the method for dispersing paraffin crystals or inhibiting paraffin crystal deposition in a paraffin-containing fluid.

Another aspect of the invention relates to a method for treating a well or vessel surface to reduce the deposition of paraffin crystals on the well or vessel surface. The method comprises treating the well or vessel surface with a resin composition comprising an effective amount of a resin. The resin comprises one or more modified calixarene compounds, each modified calixarene compound comprising 4-20 units of formula

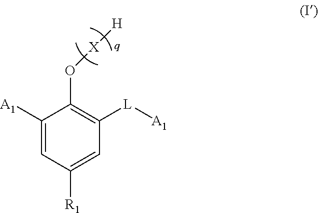

and/or formula

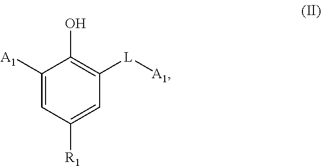

wherein each X is independently the same or different moiety, each moiety having a structure of

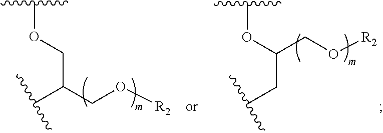

each R₁ is independently a H, C₁ to C₃₀ alkyl, phenyl, or arylalkyl; each R₂ is independently a H, C₁ to C₂₀ branched or unbranched alkyl which may optionally be substituted with one or more glycidyl ether units of the formula

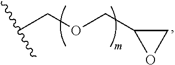

C₂ to C₁₀ alkenyl, or C₅ to C₁₀ aryl; each L is independently selected from the group consisting of —CH₂—, —C(O)—, —CH(R₃)—, —(CH₂)ₙ—O—(CH₂)ₙ—, —C(R₃)₂—, and —S—; each R₃ is independently a C₁-C₆ alkyl; each m is independently an integer from 0 to 10; each n is independently an integer from 1 to 2; each q is independently an integer from 1 to 100; each A₁ represents a direct covalent bond to an adjacent unit of formula (I′) or formula (II) such that there is one L group between adjacent units, whereby the total units in the calixarene compound form a ring; and wherein units of formula (I′) make up from about 35% to 100% of the overall units present in the calixarene compound. The treatment reduces the deposition of paraffin crystals on the well or vessel surface.

The resin used in the method for treating a well or vessel surface to reduce the deposition of paraffin crystals on the well or vessel surface is the same stabilized (or solubilized) phenolic resin described in the above embodiments. As discussed above, after the stabilization (or solubilization) modifications, the phenolic resin becomes the solubilized calixarene resin that is soluble, or at least partially soluble, in a paraffin-containing fluid or a hydrocarbon solvent. Accordingly, all the descriptions in the above embodiments relating to the stabilized (or solubilized) phenolic resin and the process of preparing thereof are applicable in the method for treating a well or vessel surface to reduce the deposition of paraffin crystals on the well surface.

The surface to be treated by the resin composition includes any surface that is in contact or has been in contact with a paraffin-containing petroleum fluid, and can be the surface of a well or any vessel that has the problem of paraffin wax deposition during oilfield operations. The surface to be treated can include wells (such as a gas well or oil well), pipelines, flowlines, tanks, tank cars, separation vessels, and other processing vessels in which paraffin wax deposition may occur. For instance, the surface to be treated can be the surfaces of artificial lift pump components, such as the components for rod pumps (also referred to as “sucker rod pumps”).

The resin can be premixed with a fluid to form a fluid resin composition to treat the well or vessel surface. The solubilized calixarene resin should be soluble or at least partially soluble in the fluid to be premixed therewith. The fluid can be any hydrocarbon fluid in the oilfield including, but not limited to, a crude oil, home heating oil, lubricating oil (such as an engine oil), and natural gas. These oilfield hydrocarbon fluids typically contain paraffin or paraffin wax.

Alternatively, the fluid can be a hydrocarbon solvent that may or may not contain paraffin or paraffin wax, acting as a fluid carrier for the resin composition to be contacted with the well or vessel surface to treat the surface or the paraffin-containing fluid itself. Suitable hydrocarbon solvents include, but are not limited to, alkanes (such as C₄-C₂₄ n-alkanes; e.g., C₅-C₁₆ n-alkanes), cycloalkanes (such as C₃-C₂₄ cycloalkanes; e.g., C₅-C₁₆ cycloalkanes), aromatic hydrocarbons (such as alkylbenzenes or naphthalenes; e.g., a C₇-C₁₂ aromatic hydrocarbon solvent), and combinations thereof. Exemplary hydrocarbon solvents are kerosene, diesel, heptane, benzene, toluene, xylene, Solvesso™ aromatic fluids (C₉-C₁₂ aromatic hydrocarbon solvents), and combinations thereof.

The fluid can also be a pre-mixture of any hydrocarbon fluid in the oilfield discussed above and any hydrocarbon solvent discussed above. For instance, the fluid can be a produced crude oil or lubricating oil, premixed with any hydrocarbon solvent discussed above.

Alternatively, the resin compositions can be contacted with the well or vessel surface directly (e.g., by injecting the resin composition into a well or vessel) at any point where it would be desirable to inhibit the deposition of paraffin or paraffin wax. For example, the resin compositions can be injected downhole at or near the producing section of the well. Alternatively, the resin compositions can be injected near the top of the well or even into separation devices used to separate hydrocarbons from aqueous components of a formation fluid, or into other process streams containing petroleum fluids. During the injection, the resin compositions can mix with any fluid already contained in the well or vessel; e.g., a crude oil, a formation fluid, etc.

The application of the resin composition to treat the well or vessel surface can be a preventive treatment (i.e., to prevent the deposition of paraffin crystals on the well or vessel surface) or a remedial treatment (i.e., to treat a surface that already shows signs of paraffin deposition).

Moreover, all the above embodiments relating to the fluid, the hydrocarbon fluid, the paraffin-containing fluid, the amounts of paraffin or paraffin wax contained in the paraffin-containing fluid, the amounts or dosages of the solubilized calixarene resin in the fluid such as the paraffin-containing fluid, the evaluating methods for the paraffin inhibition performance, and the paraffin inhibition abilities of the solubilized calixarene resins described in the embodiments relating to the paraffin-containing fluid composition are applicable in the method for treating a well or vessel surface to reduce the deposition of paraffin crystals on the well or vessel surface.

Additional aspects, advantages and features of the invention are set forth in this specification, and in part will become apparent to those skilled in the art on examination of the following, or may be learned by practice of the invention. The inventions disclosed in this application are not limited to any particular set of or combination of aspects, advantages and features. It is contemplated that various combinations of the stated aspects, advantages and features make up the inventions disclosed in this application.

### EXAMPLES

The following examples are given as particular embodiments of the invention and to demonstrate the practice and advantages thereof. It is to be understood that the examples are given by way of illustration and are not intended to limit the specification or the claims that follow in any manner.

### Example 1: Synthesis of a Mixture of Calixarene/Linear Alkylphenolic Resins Based on Para-Tert-Butylphenol and Para-Nonylphenol

A reaction vessel was charged with para-butylphenol and para-nonylphenol, Solvesso™ 150ND solvent (an aromatic solvent commercially available from ExxonMobil Chemicals), and sodium hydroxide. Formalin was added to the reaction mixture over a period of 0.5 to 1.5 hours. The reaction mixture was then heated to reflux and the reaction was completed within 3-4 hours, Solvesso™ 150 solvent was added to the reaction mixture to adjust the percentage of the resulting resins to 53-55 wt %. During the reaction, the product started to precipitate out of the resin solution. The final yield was 97%, and the appearance of the product was a suspension of partially insoluble material.

Samples of the final product were left under room temperature, and placed in the freezer at −25° C. for 24 hours. The insoluble solid precipitate was isolated and weighted.

### Example 2: Stabilization of the Calixarene with n-Butyl Glycidyl Ether

80.8 g of the resin prepared in Example 1, as described above, was added (solid content of 55.13%) in A150ND solvent (0.24 molar equivalents of phenolic hydroxyl units; commercially available from Shell) and 30.4 g of n-butyl glycidyl ether (0.96 molar equivalents of glycidyl ether in relation to the phenolic hydroxyl units) were added to a 250 ml flask equipped with mixing, heat and a reflux condenser. Heat and mixing were started and at 98° C., 0.52 g of 2-methylimidazole was added to the slurry. At 144° C. darkening of the reaction mixture was observed as the reaction product became soluble in the A-150ND solvent. Upon reaching 150° C. the reaction mixture was clear. The clear solution was then held at 150° C. for one hour then cooled and 111.64 g of the reaction product was discharged to a glass jar.

The final product had a viscosity of 426 cP at 25° C. and a MW of 2244, which is higher than the starting resin prepared in Example 1 with a MW of 1593. Due to co-elution with the A-150ND solvent, the % residual n-butyl glycidyl ether was not able to be analyzed by GC, but assumed to be ˜2% in the final product based on reaction carried out in A-150 solvent, which does not co-elute with n-butylglycidyl ether. The final product showed no precipitation after being stored for 3 days in the freezer at −25° C.

### Example 3: Paraffin Deposition Inhibition Using the Calixarene Stabilized with n-Butyl Glycidyl Ether (Solubilized Calixarene Resin)

A simulated waxy crude oil was prepared by adding 5.7 wt % of paraffin waxes (Sasol wax, Sandton, South Africa) into a mixture of kerosene, heptane and xylenes. This simulated waxy crude oil formulation is shown in Table 1 below.

TABLE 1
Simulated Crude Oil Formulation

| | |
|---|---|
| Kerosene | 66.0% |
| Heptane | 18.9% |
| Xylene | 9.4% |
| Sasolwax 4610 | 2.8% |
| Sasolwax 4110 | 1.9% |
| Sasolwax C80M | 0.9% |
| Sasolwax H1 | 0.1% |

The simulated waxy crude was conditioned in an oven at a temperature of 100° C. for about 1-2 hours, and then partitioned into 6 cold finger test jars, each being equipped with a magnetic stir rod. The jars were then treated with a solubilized calixarene resin, prepared according to Example 2, at a dosage rate of 1000 ppm, 500 ppm, 250 ppm, and 100 ppm (i.e., μL/L, which is commonly used as an approximation for ppm in the oilfield industry) of a 55 wt % active resin product solution in Solvesso 150 solvent, respectively. That is to say, for instance, 100 ppm dosage rate refers to adding 100 μL resin solution (55 wt % active product in Solvesso 150 solvent) per 1 L of Simulated Crude Oil Formulation (as listed in Table 1). Once treated, the jars were secured to the cold finger probes of the Multi-Place Cold Finger Model 0.62 (F5 Technologie GmbH, Wunstorf, Germany) and placed into a hot water bath at a temperature of 38° C. Magnetic stirring at 350 rpm was turned on and the cold finger probes were activated to cool to 29° C. The samples were maintained in this way for about 16 hours. The jars were then detached from the cold finger probes and the waxy solution was drained off the probes.

The deposited wax on the cold finger probes was assessed gravimetrically by scraping the deposit off of the probes and onto weighing paper. Percent inhibition of the paraffin wax deposition by the resin was determined by comparing the mass of the deposit from the control (Mass of Deposit_{control}, i.e., the sample that was not treated with the resin) and the mass of the deposit from the treated sample (Mass of Depositₜᵣₑₐₜₘₑₙₜ, i.e., the sample that was treated with the resin), using the following formula:

$$\% Inhibition = ( \frac{Mass of {Deposit}_{control} - Mass of {Deposit}_{treatment}}{Mass of {Deposit}_{control}} ) \times 100$$

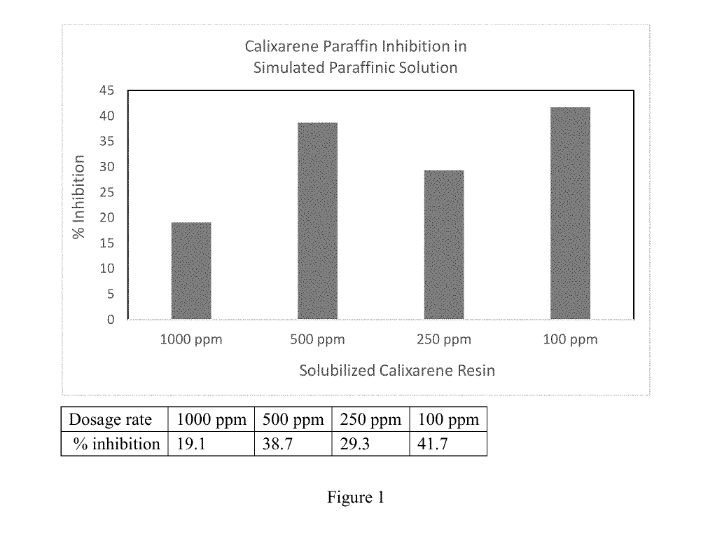

FIG. 1 shows the paraffin inhibition performance (% inhibition as described above) of the solubilized calixarene resin in the simulated waxy crude at different dosage levels (1000 ppm, 500 ppm, 250 ppm, and 100 ppm, respectively). The data show that the solubilized calixarene resin provided paraffin inhibition at each dosage level compared to the control, i.e., the sample that was not treated with the resin, which has 0% paraffin inhibition, as the % inhibition was calculated relative to the control.

In a cold finger test in which the paraffin wax deposition may occur for 16 hours, the solubilized calixarene resin had shown about 42% inhibition of paraffin wax deposition at the dosage level of 100 ppm.

Although preferred embodiments have been depicted and described in detail herein, it will be apparent to those skilled in the art that various modifications, additions, substitutions, and the like can be made without departing from the spirit of the invention and these are therefore considered to be within the scope of the invention as defined in the claims which follow.

We claim:

1. A method for dispersing paraffin crystals or inhibiting paraffin crystal deposition in a paraffin-containing fluid, comprising:
adding to a paraffin-containing fluid, an effective amount of a resin at least partially soluble in the paraffin-containing fluid, wherein the resin comprises one or more modified calixarene compounds, each modified calixarene compound comprising 4-20 units of formula (I′) and/or formula (II): 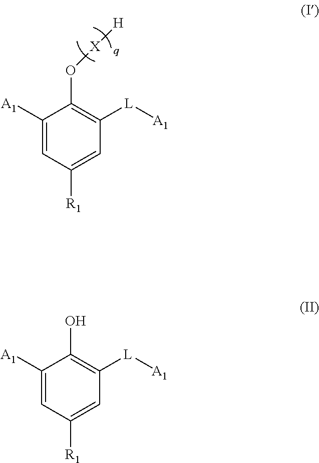
wherein:
each X is independently the same or different moiety, each moiety having a structure of 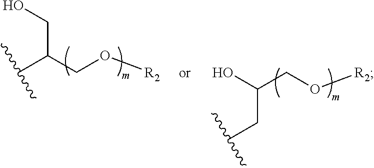
each R₁ is independently a H, C₁ to C₃₀ alkyl, phenyl, or arylalkyl;
each R₂ is independently a H, C₁ to C₂₀ branched or unbranched alkyl which may optionally be substituted with one or more glycidyl ether units of the formula 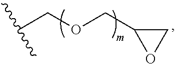
C₂ to C₁₀ alkenyl, or C₅ to C₁₀ aryl;
each L is independently selected from the group consisting of —CH₂—, —C(O)—, —CH(R₃)—, —(CH₂)ₙ—O—(CH₂)ₙ—, —C(R₃)₂—, and —S—;
each R₃ is independently a C₁-C₆ alkyl;
each m is independently an integer from 0 to 10;
each n is independently an integer from 1 to 2;
each q is independently an integer from 1 to 100;
each A₁ represents a direct covalent bond to an adjacent unit of formula (I′) or formula (II) such that there is one L group between adjacent units, whereby the total units in the calixarene compound form a ring; and
wherein units of formula (I′) make up from about 35% to 100% of the overall units present in the calixarene compound,
wherein the resin disperses the paraffin in the paraffin-containing fluid and/or inhibits the deposition of the paraffin crystals.

2. The method of claim 1, wherein each m is 1.

3. The method of claim 2, wherein each R₂ is independently selected from the group consisting of hydrogen, methyl, ethyl, n-propyl, iso-propyl, n-butyl, iso-butyl, tert-butyl, allyl, ethylhexyl, octyl, nonyl, decyl, phenyl, nonylphenyl, and hexadecyl; or is a C₁ to C₈ branched or unbranched alkyl substituted with one or more glycidyl ether units of the formula

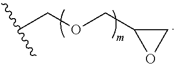

4. The method of claim 3, wherein each R₂ is n-butyl or

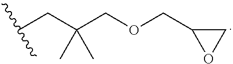 [SMILES: *CC(C)(C)COCC1CO1]

5. The method of claim 1, wherein each R₁ is independently a C₄ to C₁₂ alkyl or C₂₄ to C₂₈ alkyl.

6. The method of claim 1, wherein the total number of units in the modified calixarene compounds is from 4-8.

7. The method of claim 1, wherein q is 1 in one or more units in the modified calixarene compounds.

8. The method of claim 1, wherein the paraffin-containing fluid is a hydrocarbon fluid selected from the group consisting of a crude oil, home heating oil, lubricating oil, and natural gas.

9. A method for treating a well or vessel surface to reduce the deposition of paraffin crystals on the well or vessel surface, comprising:
treating the well or vessel surface with a resin composition comprising an effective amount of a resin comprising one or more modified calixarene compounds, each modified calixarene compound comprising 4-20 units of formula (I′) and/or formula (II): 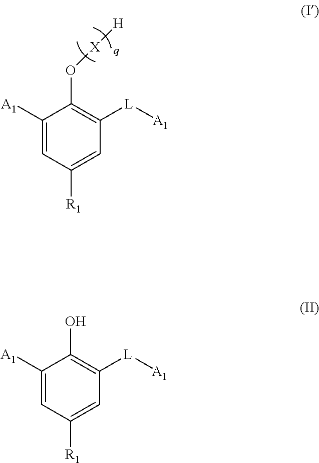
wherein:
each X is independently the same or different moiety, each moiety having a structure of 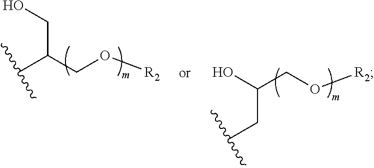
each R₁ is independently a H, C₁ to C₃₀ alkyl, phenyl, or arylalkyl;
each R₂ is independently a H, C₁ to C₂₀ branched or unbranched alkyl which may optionally be substituted with one or more glycidyl ether units of the formula 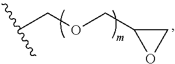
C₂ to C₁₀ alkenyl, or C₅ to C₁₀ aryl;
each L is independently selected from the group consisting of —CH₂—, —C(O)—, —CH(R₃)—, —(CH₂)ₙ—O—(CH₂)ₙ—, —C(R₃)₂—, and —S—;
each R₃ is independently a C₁-C₆ alkyl;
each m is independently an integer from 0 to 10;
each n is independently an integer from 1 to 2;
each q is independently an integer from 1 to 100;
each A₁ represents a direct covalent bond to an adjacent unit of formula (I′) or formula (II) such that there is one L group between adjacent units, whereby the total units in the calixarene compound form a ring; and
wherein units of formula (I′) make up from about 35% to 100% of the overall units present in the calixarene compound,
wherein the treatment reduces the deposition of paraffin crystals on the well or vessel surface.

10. The method of claim 9, wherein each m is 1.

11. The method of claim 9, wherein each R₂ is independently selected from the group consisting of hydrogen, methyl, ethyl, n-propyl, iso-propyl, n-butyl, iso-butyl, tert-butyl, allyl, ethylhexyl, octyl, nonyl, decyl, phenyl, nonylphenyl, and hexadecyl; or is a C₁ to C₈ branched or unbranched alkyl substituted with one or more glycidyl ether units of the formula

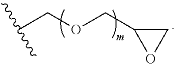

12. The method of claim 11, wherein each R₂ is n-butyl or

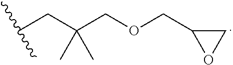 [SMILES: *CC(C)(C)COCC1CO1]

13. The method of claim 9, wherein each R₁ is independently a C₄ to C₁₂ alkyl or C₂₄ to C₂₈ alkyl.

14. The method of claim 9, wherein the total number of units in the modified calixarene compounds is from 4-8.

15. The method of claim 9, wherein q is 1 in one or more units in the modified calixarene compounds.

16. The method of claim 9, wherein the resin composition further comprises a hydrocarbon fluid that the resin is at least partially soluble in, selected from the group consisting of a crude oil, home heating oil, lubricating oil, and natural gas.

17. The method of claim 16, wherein the hydrocarbon fluid comprises one or more hydrocarbon solvents selected from the group consisting of kerosene, diesel, heptane, benzene, toluene, xylene, C₉-C₁₂ aromatic hydrocarbon solvents, and combinations thereof.

18. A paraffin-containing fluid composition comprising:
a) a paraffin-containing fluid; and
b) a resin at least partially soluble in the paraffin-containing fluid, for dispersing the paraffin in the fluid composition and/or inhibiting the deposition of the paraffin crystals, the resin comprising one or more modified calixarene compounds, each modified calixarene compound comprising 4-20 units of formula (I′) and/or formula (II): 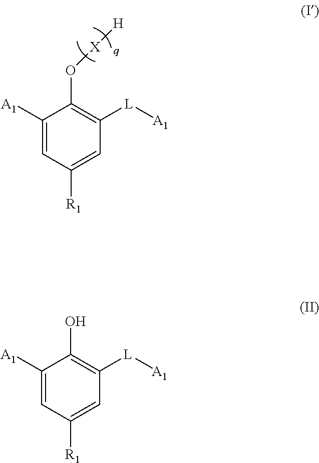
wherein:
each X is independently the same or different moiety, each moiety having a structure of 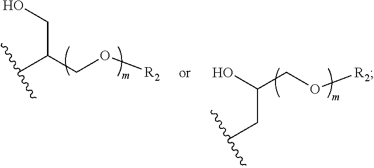
each R₁ is independently a H, C₁ to C₃₀ alkyl, phenyl, or arylalkyl;
each R₂ is independently a H, C₁ to C₂₀ branched or unbranched alkyl which may optionally be substituted with one or more glycidyl ether units of the formula 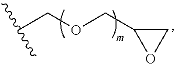
C₂ to C₁₀ alkenyl, or C₅ to C₁₀ aryl;
each L is independently selected from the group consisting of —CH₂—, —C(O)—, —CH(R₃)—, —(CH₂)ₙ—O—(CH₂)ₙ—, —C(R₃)₂—, and —S—;
each R₃ is independently a C₁-C₆ alkyl;
each m is independently an integer from 0 to 10;
each n is independently an integer from 1 to 2;
each q is independently an integer from 1 to 100;
each A₁ represents a direct covalent bond to an adjacent unit of formula (I′) or formula (II) such that there is one L group between adjacent units, whereby the total units in the calixarene compound form a ring; and
wherein units of formula (I′) make up from about 35% to 100% of the overall units present in the calixarene compound.

19. The paraffin-containing fluid composition of claim 18, wherein each m is 1.

20. The paraffin-containing fluid composition of claim 19, wherein each R₂ is independently selected from the group consisting of hydrogen, methyl, ethyl, n-propyl, iso-propyl, n-butyl, iso-butyl, tert-butyl, allyl, ethylhexyl, octyl, nonyl, decyl, phenyl, nonylphenyl, and hexadecyl; or is a C₁ to C₈ branched or unbranched alkyl substituted with one or more glycidyl ether units of the formula

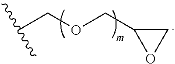

21. The paraffin-containing fluid composition of claim 20, wherein each R₂ is n-butyl or

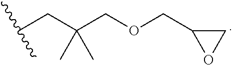 [SMILES: *CC(C)(C)COCC1CO1]

22. The paraffin-containing fluid composition of claim 18, wherein each R₁ is independently a C₄ to C₁₂ alkyl or C₂₄ to C₂₈ alkyl.

23. The paraffin-containing fluid composition of claim 18, wherein the total number of units in the modified calixarene compounds is from 4-8.

24. The paraffin-containing fluid composition of claim 18, wherein the paraffin-containing fluid is a hydrocarbon fluid selected from the group consisting of a crude oil, home heating oil, lubricating oil, and natural gas.

25. The paraffin-containing fluid composition of claim 18, wherein the resin improves the paraffin dispersion and/or inhibits the paraffin deposition by at least 20% compared to a paraffin-containing fluid composition that does not contain the resin.
